(19) United States
(12) Patent Application Publication
(10) Pub. No.: US 2005/0173180 A1
(43) Pub. Date: Aug. 11, 2005

(54) Power train for small recreational vehicle

(76) Inventors: David D. Hypes, Salem, IN (US); Vance E. Coble, Salem, IN (US); Orville R. McDonner, Salem, IN (US); Kenneth J. Stenz, Mt. Calvary, WI (US); Trent Pickerill, Pekin, IN (US); C. Paul Cox, Salem, IN (US)

Correspondence Address: BAKER & DANIELS LLP;111 E. WAYNE STREET, SUITE 800, FORT WAYNE, IN, 46802, US

(21) Appl. No.: 10/960,833

(22) Filed: Oct. 7, 2004

Related U.S. Application Data
(60) Provisional application No. 60/510,646, filed on Oct. 10, 2003.

(51) Int. Cl. B60K 17/00

(52) U.S. Cl. 180/292; 180/58; 475/2

(57) ABSTRACT

A small vehicle, such as a go-kart, which includes a power train unit including an engine and a transaxle which are attached to the frame of the vehicle as an integrated component. In this manner, easy installation of the engine and transaxle to the frame of the vehicle is facilitated. An adjustable engine mounting system is provided, which allows fine adjustment of the position of the engine to vary the tension of the belt drive which drivingly couples the engine and the transaxle. The transaxle includes a selective lock-out feature which allows an operator to lock out selected forward or reverse gears to thereby modify or limit the performance characteristics of the go-kart as desired to a particular application. Additionally, the transaxle includes a built-in differential which may be selectively locked out by the operator during running of the vehicle, in order to switch between “differential active” and “differential locked-out” positions.

### CROSS REFERENCE TO RELATED APPLICATION

This application claims the benefit under 35 U.S.C. §119(e) of U.S. Provisional Patent Application Ser. No. 60/510,646, entitled POWER TRAIN FOR SMALL VEHICLE, filed on Oct. 10, 2003, assigned to the Assignee of the present patent application, the entire disclosure of which is expressly incorporated by reference herein.

### BACKGROUND OF THE INVENTION

1. Field of the Invention

The present invention relates to small vehicles, such as go-karts, or golf carts. In particular, the present invention relates to a power train for such vehicles.

2. Description of the Related Art

Known small vehicles include recreational vehicles, such as go-karts and golf carts. Typically, these vehicles include a vehicle frame to which a small internal combustion engine, such as a single or two-cylinder engine, is attached. Typically, the power train of such vehicles includes a drive chain which is coupled in a driving manner between a first sprocket on the crankshaft of the engine and a second sprocket on the axle of the vehicle.

A problem with these types of power trains is that the chain which drivably couples the engine to the axle is typically lengthy and is also exposed, and therefore may collect dirt and dust during operation of the vehicle, which could potentially lead to a decrease in the operational life of the chain, or to breakage of the chain. Additionally, if torque converters are used on the engine crankshaft or vehicle axle, exposure of the torque converters to dirt and debris can foul the torque converters, potentially causing the sheaves of the torque converters to stick together and not function properly.

In order to cover the chain and/or the torque converters, some small vehicles include an arrangement of guards and covers which are attached to the engine and frame of the vehicle. Problematically, these guard or cover arrangements often include numerous individual components, are often difficult to assemble, and do not always effectively prevent fouling of the chain drive or the torque converters.

Currently, in the go-kart industry, the power trains of go-karts are usually custom built from standard off-the-shelf components, such as existing single or two cylinder engines, differentials, torque converters, chains, sprockets, and bearings, for example. However, because many of these components are originally manufactured for applications other than go-karts, the go-kart manufacturer will typically have to modify existing power train components for the go-kart application or meet the specifications of the go-kart purchaser. For example, go-karts which are made for performance intensive applications, such as racing, are often built with very different drive trains than go-karts which are made for recreational use by potentially inexperienced users, such as by children in amusement parks.

Problematically, this known approach to manufacturing go-karts requires the go-kart manufacturer to purchase and inventory a large number of existing, off-the-shelf parts. Further, the need to modify existing off-the-shelf parts as necessary to suit the particular go-kart application and/or the particular specifications of the purchaser requires a considerable amount of manufacturing expertise on the part of the assembly engineers of the go-kart manufacturer, such that assembling the go-karts is typically a time-consuming and labor intensive operation.

Additionally, many go-karts include separate, self-contained differentials which are attached to the axles of the go-kart such that the wheels and the axles may rotate at different speeds in order to facilitate turning the go-kart around corners, for example. Problematically, and as is well known with differentials, when the go-kart is driven in dirt, mud, or other environments in which the wheels of the go-kart cannot obtain sufficient traction, for example, one axle and wheel may be driven while the opposite axle and wheel remain stationary and the go-kart will become stuck. Conversely, in go-karts which do not include differentials, each axle and wheel are constrained to rotate at the same speed, which adversely impacts the performance of the go-kart, especially in turning the go-kart around corners.

What is needed is a small vehicle having a power train which is an improvement over the foregoing.

### SUMMARY OF THE INVENTION

The present invention provides a small vehicle, such as a go-kart, having a power train unit including an engine and a transaxle which are attached to the frame of the vehicle as a single, integrated component. In this manner, easy installation of the engine and transaxle to the frame of the vehicle is facilitated. An adjustable engine mounting system is provided, which allows adjustment of the position of the engine to vary the tension of the belt drive which drivingly couples the engine and the transaxle. The transaxle includes a selective lock-out feature which allows an operator to lock out selected forward or reverse gears to thereby modify or limit the performance characteristics of the go-kart as desired to a particular application. Additionally, the transaxle includes a built-in differential which may be selectively locked out by the operator during running of the vehicle, in order to switch between “differential active” and “differential locked-out” positions.

In one embodiment, a small vehicle includes a power train unit in which an engine, an adjustable engine mounting assembly, and a transaxle are integrated into a single unit which is easily attached to the frame of the vehicle with minimal assembly steps. For example, the power train unit may be assembled at a first location as a single unit or module, and then shipped to a second location for easy installation in the vehicle. Thus, the integrated power train unit greatly simplifies the overall assembly of the vehicle by eliminating the need to assemble and/or modify a number of separate and individual power train components, such as an engine or differential which, in known small vehicle designs, are separately attached to the frame of the vehicle.

In an alternative embodiment, the engine is directly bolted to the transaxle.

The transaxle of the power train unit is equipped with a selective lockout feature including a plurality of lock pins which are selectively inserted into the transaxle at various locations to block movement of the gear shift fork. For example, a lock pin may be used to prevent the shift fork from shifting the transaxle to a reverse drive position, and one or two lock pins may be used to prevent the shift fork from shifting the transaxle to forward drive positions in which second or third forward gears are used, thereby limiting the forward speed of the vehicle. In this manner, the performance characteristics of the transaxle and, in turn, the vehicle, may be tailored to suit a particular application in which the vehicle is used. Additionally, the lock pins are configured such that they may only be installed or removed by a specially-configured tool, thereby preventing unauthorized modification of the performance characteristics of the transaxle. Thus, an owner of the vehicle may selectively restrict high speed operation of the vehicle, for example, when a potentially inexperienced user is to operate the vehicle.

Advantageously, the differential lockout of the transaxle allows the differential to be selectively operated between a first or “differential active” position in which the differential facilitates rotation of the left and right rear vehicle axles at different speeds, such that the vehicle may be easily driven through turns, and a second or “differential locked out” position in which the left and right rear vehicle axles are not permitted to rotate at different speeds, such that the rear wheels of the vehicle may obtain maximum traction when the vehicle is driven in dirt or mud, for example.

In one form thereof, the present invention provides a small vehicle, including a vehicle frame; a power train unit attached to the frame, the power train unit including an internal combustion engine having a horizontally disposed crankshaft; a transaxle attached to the engine, the transaxle including a horizontally disposed input shaft; and a drive member drivably coupling the output shaft of the engine to the input shaft of the transaxle.

In one form thereof, the present invention provides a small vehicle, including a vehicle frame; a power train unit attached to the frame, the power train unit including a mounting assembly attached to the frame, an internal combustion engine attached to the mounting assembly, the engine including an output shaft; a transaxle attached to the mounting assembly, the transaxle including an input shaft; and a drive member drivably coupling the output shaft of the engine to the input shaft of the transaxle.

In another form thereof, the present invention provides a transaxle, including a housing including a rotatably driven shaft; at least two drive members rotatably supported upon the shaft; a selector mechanism disposed within the housing, the selector mechanism movable to drivingly couple the shaft with a selected one of the at least two drive members; at least one lock member selectively insertable within the housing into blocking relationship with the selector mechanism to prevent the selector mechanism from drivingly coupling the shaft with at least one of the at least two drive members.

In a further form thereof, the present invention provides a transaxle, including a housing; a pair of axles rotatably supported by the housing; a differential carried within the housing, the differential including a casing rotatably supported by the axles, the casing rotatably supporting a first pair of gears, the first pair of gears each in engagement with a second pair of gears fixed respectively to the pair of axles; and a differential lockout mechanism, including a shift member constrained for rotation with one of the axles, the shift member translatable on the one axle between a first position in which the shift member does not engage the casing whereby the pair of axles may rotate with respect to one another at different speeds, and a second position in which the shift member engages the casing to rotatably couple the shift member and the one axle to the casing whereby the pair of axles are rotatably coupled to one another.

### BRIEF DESCRIPTION OF THE DRAWINGS

The above-mentioned and other features and advantages of this invention, and the manner of attaining them, will become more apparent and the invention itself will be better understood by reference to the following description of an embodiment of the invention taken in conjunction with the accompanying drawings, wherein:

FIG. 1 is a perspective view of an exemplary small vehicle, shown as a go-kart, including the power train and other features of the present invention;

FIG. 2 is a perspective view of the rear portion of the go-kart of FIG. 1; showing a power train unit mounted to a sub-frame of the go-kart;

FIG. 3 is a perspective view of the sub-frame member of the go-kart, showing the mounting assembly to which the transaxle is mounted;

FIG. 4 is a perspective view of a portion of the go-kart, showing the engine and an exemplary accelerator pedal and engine throttle assembly;

FIG. 5 is a perspective view of a portion of the go-kart, showing an exemplary brake assembly;

FIG. 6 is a perspective view of a first power train unit, showing the engine, a portion of a first mounting assembly, and the transaxle;

FIG. 7 is an exploded view of the first mounting assembly;

FIG. 8 is a perspective view showing an exemplary manner in which the rear of the transaxle may be mounted to a portion of the sub-frame of the go-kart;

FIG. 9 is a perspective view of a second power train unit, showing the engine, a portion of a second mounting assembly, and the transaxle;

FIG. 10 is an upper perspective view of the transaxle;

FIG. 11 is a sectional view of the transaxle, taken along line 11-11 of FIG. 10;

FIG. 12 is a fragmentary view of a portion of the transaxle of FIGS. 10 and 11, with a portion of the transaxle cut away to view the interior of the transaxle;

FIG. 13a is a fragmentary view of a portion of the transaxle of FIGS. 10 and 11, showing the lockout tool in exploded view;

FIG. 13b is a bottom view of the tool head of the lockout tool of FIG. 13a;

FIG. 14 is a fragmentary view of the rear portion of the transaxle, with a portion of the transaxle cut away to show the differential therewithin;

FIG. 15 is a vertical sectional view through the differential, taken along the rear axles;

FIG. 16 is an exploded view of the differential casing, spring, and lock collar of the differential of FIGS. 14 and 15;

FIG. 17 is a fragmentary view of the rear portion of the transaxle, with a portion of the transaxle cut away to show the differential therewithin, the differential disposed in a differential active position;

FIG. 18 is a fragmentary view of the rear portion of the transaxle, with a portion of the transaxle cut away to show the differential therewithin, the differential disposed in a locked out position; and

FIG. 19 is a fragmentary view of a portion of the front of the go-kart, showing a shift quadrant and differential lockout lever.

Corresponding reference characters indicate corresponding parts throughout the several views. The exemplifications set out herein illustrates one preferred embodiment of the invention, and such exemplifications are not to be construed as limiting the scope of the invention any manner.

### DETAILED DESCRIPTION

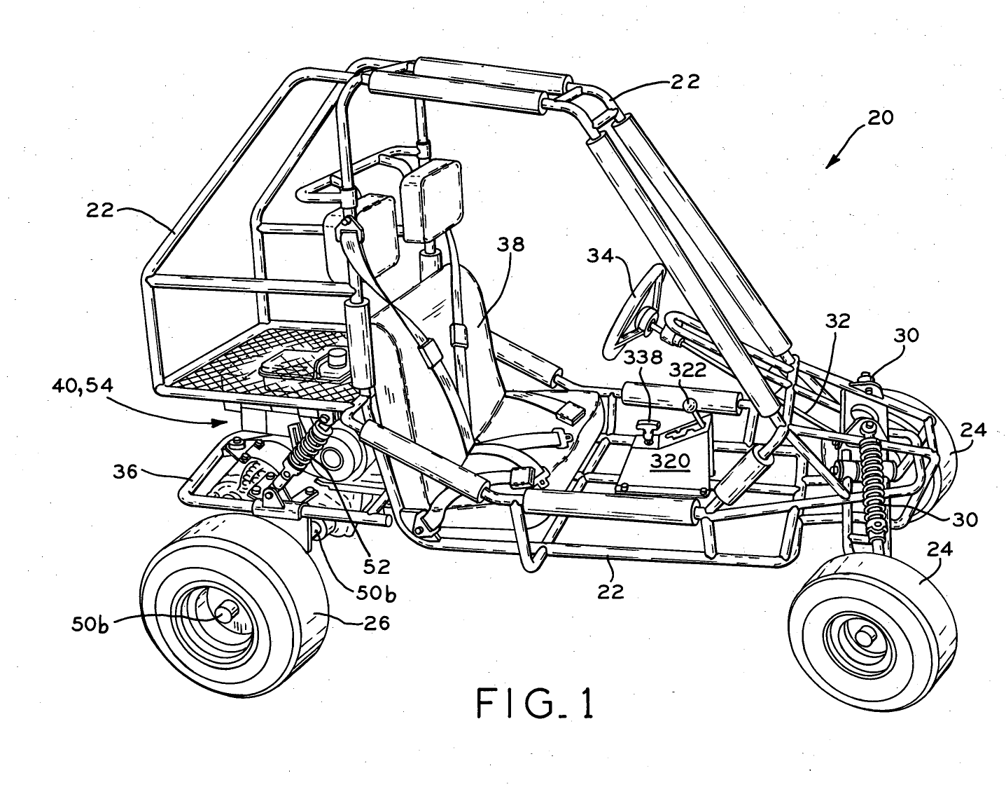

Referring to FIG. 1, go-kart 20 is shown as an exemplary small vehicle which includes the power train and other aspects of the present invention, as discussed below. Although the power train and other aspects of the present invention are shown herein and described below in a go-kart application, the power train and other aspects of the present invention are also applicable to other types of small vehicles, such as golf carts, for example.

Go-kart 20 generally includes a frame 22 having a front suspension for supporting front wheels 24, and a rear suspension for supporting rear wheels 26. The front suspension includes a pair of left and right front axles (not visible in FIG. 1) to which left and right front wheels 24 are respectively mounted. A pair of front shocks 30 are connected at their opposite ends to frame 22 and to the left and right front axles, respectively, and independently support each of the left and right front axles and wheels 24 for movement with respect to frame 22, such as when front wheels 24 encounter a bump, for example. The front axles are each rotatably supported in bearings (not shown) carried by frame 22. The front suspension also includes steering column 32 and steering wheel 34 operably connected to front wheels 24 by a suitable steering mechanism, such as a rack-and-pinion steering mechanism, for example. Seat 38 is mounted to frame 22 for occupation by one or more operators of go-kart 20.

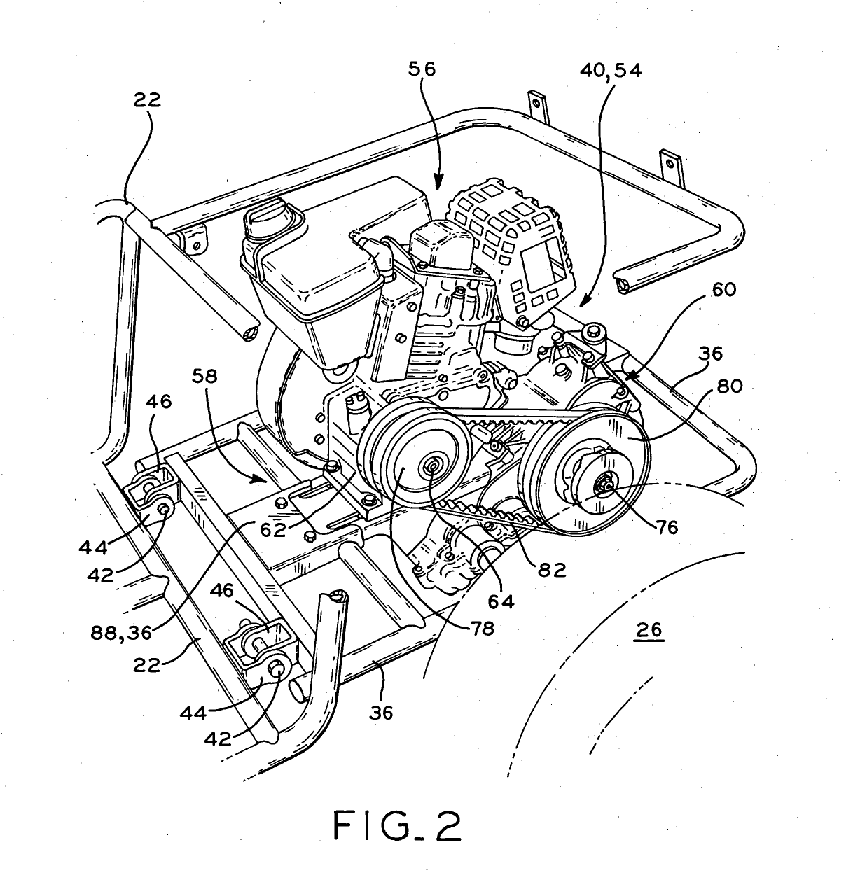

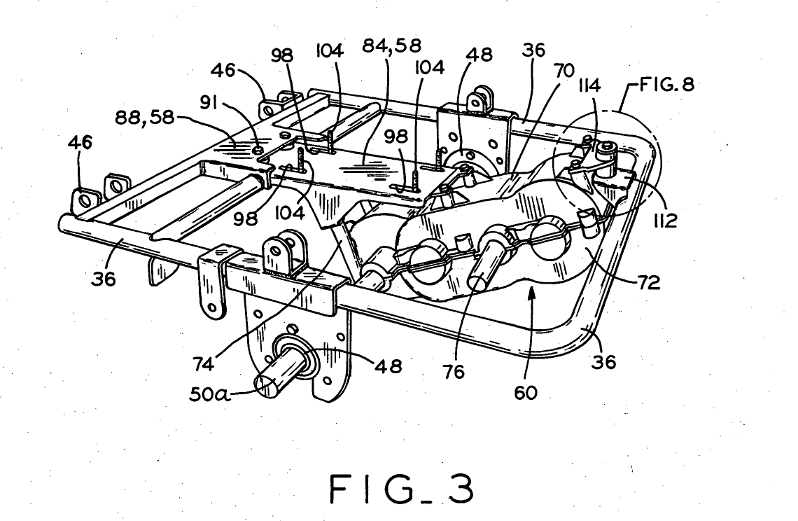

Frame 22 also includes a rear suspension, including a sub-frame 36 supporting the power train 40 of go-kart 20, with sub-frame 36 pivotally mounted to frame 22 as shown in FIG. 2. Specifically, bolts 42 are received through cooperating U-shaped devises 44 of frame 22 and U-shaped devises 46 of sub-frame 36. Sub-frame 36 additionally carries a pair of bearings 48, shown in FIG. 3, for supporting left and right rear axles 50a and 50b, respectively, on which rear wheels 26 are mounted. A pair of shocks 52 (FIG. 1) are connected at opposite ends thereof between frame 22 and sub-frame 36 to support sub-frame 36, such that sub-frame 36, rear axles 50a and 50b, and rear wheels 26 may pivot together as a unit with respect to frame 22 when rear wheels 26 encounter a bump, for example. Optionally, if an independent suspension is desired for go-kart 20, rear axles 50a and 50b may include universal joints, with rear shocks 52 connected between frame 22 of go-kart 20 and rear axles 50a and 50b to thereby allow independent pivotal movement of rear axles 50a and 50b.

Referring to FIG. 2, power train 40 of go-kart 20 includes power train unit 54 adjustably mounted to sub-frame 36 as discussed below. Power train unit 54 generally includes a small internal combustion engine 56, mounting assembly 58, and transaxle 60. Advantageously, as described below, power train unit 54 integrates engine 56, mounting assembly 58, and transaxle 60 into a single unit which is easily attached to sub-frame 36 of go-kart 20. In particular, power train unit 54 may be assembled at a first location as a single unit or module, and then shipped to a second location for installation in go-kart 20. In this manner, the assembly of go-kart 20 is simplified over known go-kart designs in which a number of individual and separate power train components, such as the engine, differential, torque converters, and drive belt where separately attached to the frame of the go-kart.

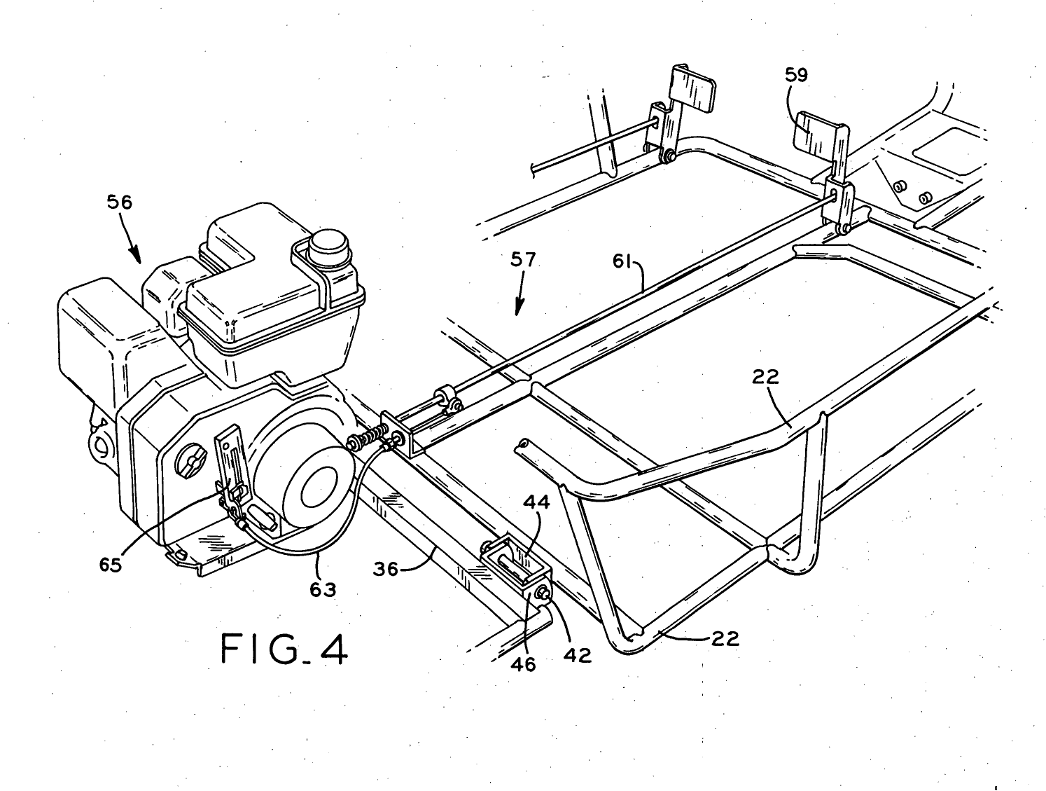

Engine 56 is a small, single or two cylinder internal combustion engine, for example, including crankcase 62 with a horizontally disposed crankshaft 64 having an output end extending externally of crankcase 62. However, with some modifications to power train unit 54, an engine having a vertically disposed crankshaft may also be used. Engine 56 may be any of a number of small single or two cylinder engines manufactured by Tecumseh Products Company of Grafton, Wis. Referring to FIG. 4, an exemplary throttle assembly 57 includes an operator-controlled accelerator pedal 59 connected to suitable linkage including rod 61 coupled to cable 63, with cable 63 in turn coupled to throttle lever 65 of engine 56. Thus, by depressing accelerator pedal 59, an operator to vary the running speed of engine 56 and in turn the speed of go-kart 20.

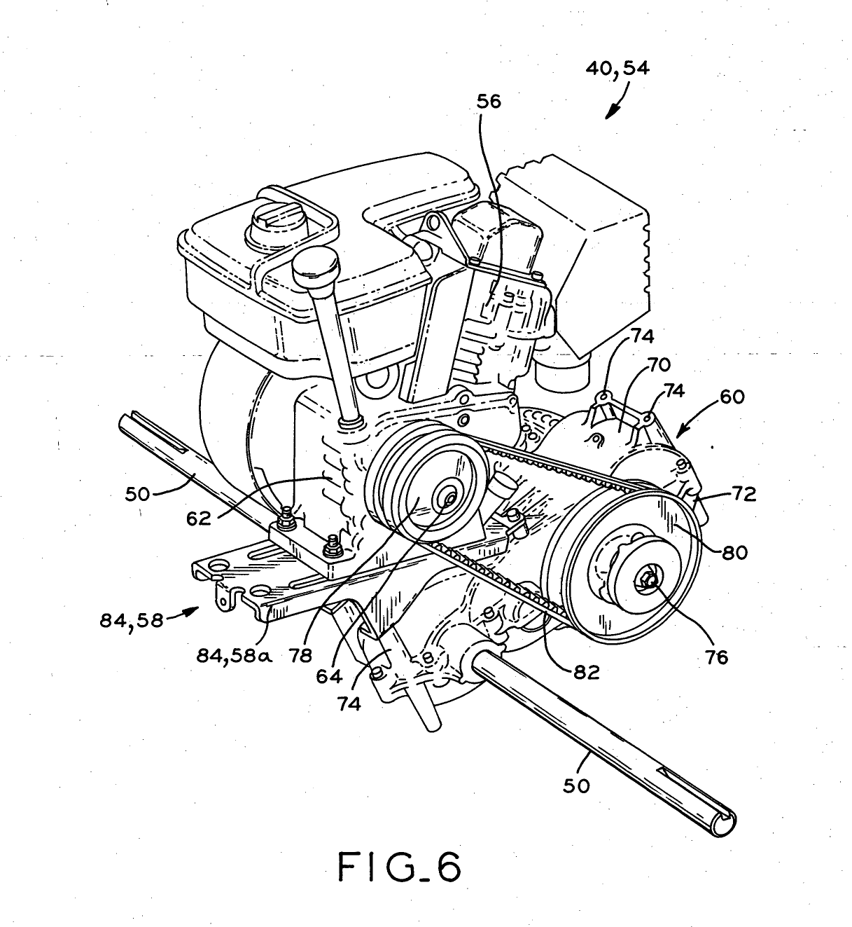

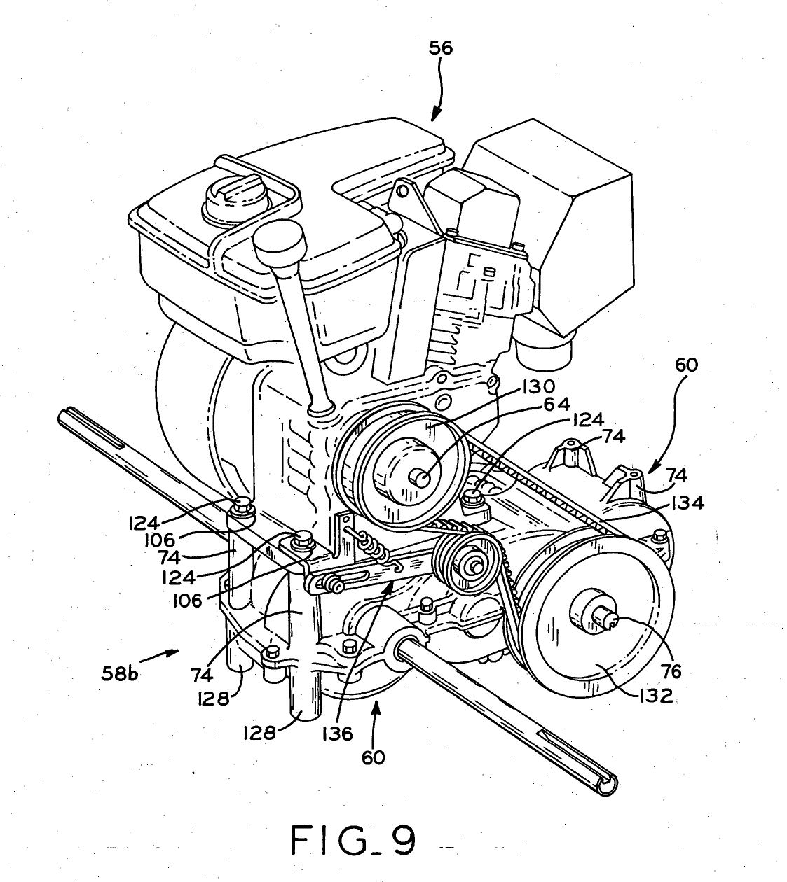

Transaxle 60 is a fully enclosed, oil-bath type transaxle which includes neutral, forward, and reverse positions with corresponding gears and gear shifting structure, as described below. Transaxle 60 additionally includes a selective drive control lockout feature and a differential with a lockout mechanism, as also discussed below. Transaxle 60 includes upper and lower transaxle casings 70 and 72, respectively. Upper casing 70 includes a plurality of mounting bosses 74 (FIG. 6) for mounting transaxle 60 to mounting assembly 58 and to sub-frame 36 in the manner described below. Transaxle 60 includes input shaft 76, and rotationally supports left and right rear axles 50a and 50b, respectively. Referring to FIG. 2, a first torque converter 78 is mounted to crankshaft 64, and a second torque converter 80 is mounted to input shaft 76 of transaxle 60, with drive belt 82 drivingly coupling first torque converter 78 to second torque converter 80 to thereby drivingly couple crankshaft 64 of engine 20 to input shaft 76 of transaxle 60. Torque converters 78 and 80 are known devices available from many commercial sources, each generally including a pair of spring-loaded sheaves for varying the drive ratio between crankshaft 64 and input shaft 76 responsive to the torque imposed upon drive belt 82. Optionally, standard pulleys (see FIG. 9) may be used in place of torque converters 78 and 80. Alternatively, rather than using torque converters 78 and 80 and belt 82, a pair of sprockets (not shown) may be mounted respectively to crankshaft 64 and to input shaft 76 of transaxle 60, with the sprockets connected by a chain to drivably couple crankshaft 64 of engine 20 to input shaft 76 of transaxle 60. A centrifugal clutch may also be used in such a chain drive.

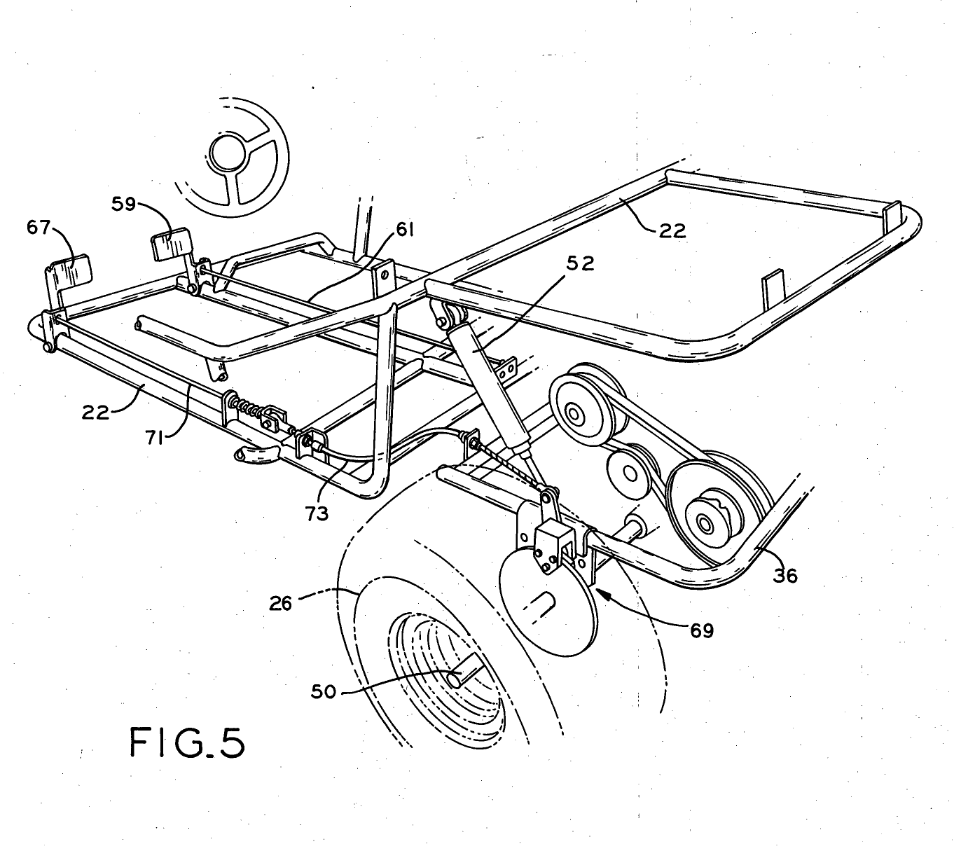

Referring to FIG. 5, an exemplary brake mechanism includes an operator-controlled brake pedal 67 connected to disc brake assembly 69 via linkage including rod 71 and cable 73, to allow an operator to apply braking force to left rear axle 50a responsive to depression of brake pedal 67.

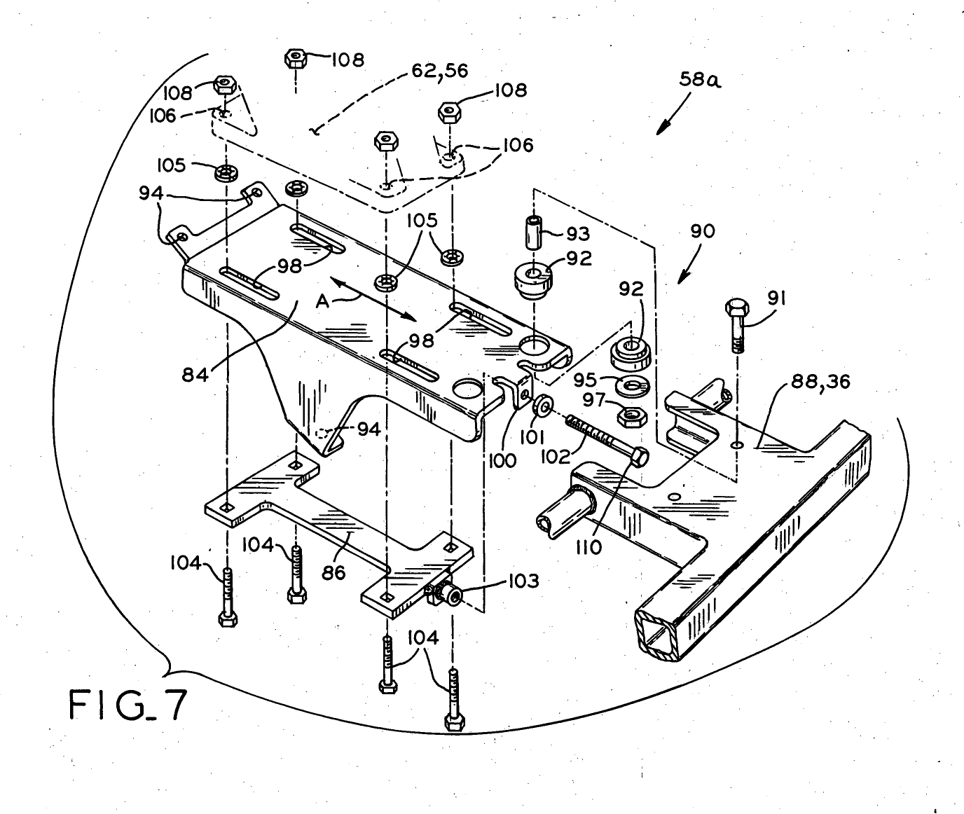

With reference to FIGS. 2, 3, 6, and 7, a first embodiment of mounting assembly 58 will be described. Referring in particular to FIG. 7, mounting assembly 58a generally includes first bracket 84 and second bracket 86. First bracket 84 is mounted to mount sleeve 88 (FIGS. 2 and 3) of sub-frame 36 by a pair of fastener assemblies 90 (one of which is shown in FIG. 7), including bolts 91, sleeves 93, washers 95, and nuts 97, with rubber bushings 92 disposed between mount sleeve 88 and first bracket 84 to absorb or dampen vibrations between sub-frame 36 and power train unit 54. First bracket 84 additionally includes a plurality of mounting holes 94 through which fasteners (not shown) are received, which extend into mounting bosses 74 of upper transaxle casing 70 to mount transaxle 60 to first bracket 84 of mounting assembly 58. First bracket 84 includes a set of four elongate slots 98 therein, which are oriented along a longitudinal axis of go-kart 20 which extends from the front of go-kart 20 to the rear of go-kart 20. Additionally, first bracket 84 includes adjusting tab 100 through which adjustment screw 102 is received. Adjustment screw 102 is retained to first bracket 84 by nut 101 and is threadably received through adjustment fitting 103 of second bracket 86.

Second bracket 86 includes a set of four bolts 104 extending therefrom which are received through slots 98 of first bracket 84. Keepers 105 may optionally be attached to bolts 104 to hold bolts 104 in a position with respect to second bracket 86 in which bolts 104 extend and project through slots 98 in first bracket 84. Bolts 104 are further received through corresponding mounting holes 106 in crankcase 62 of engine 56, and nuts 108 are received on bolts 106 to securely fasten crankcase 62 of engine 56 to mounting assembly 58a.

To adjust the location of engine 56 with respect to transaxle 60 along the front-to-back longitudinal axis of go-kart 20, nuts 108 are loosened upon bolts 104 to permit engine 56 and second bracket 86 to slide with respect to first bracket 84 along arrow A in FIG. 7, with bolts 104 sliding within slots 98 of first bracket 84. The location of engine 56 and second bracket 86 is adjusted by turning adjustment nut 110 on adjustment screw 102 using a suitable tool, thereby rotating adjustment screw 102 to move second bracket 86 along adjustment screw 102 and, in turn, to move second bracket 86 and engine 56 together as a unit toward or away from transaxle 60 along first bracket 84. In this manner, mounting assembly 58a permits the location of engine 56 to be adjusted with respect to transaxle 60, for example, in order to vary the tension on drive belt 82 (FIG. 2) which drivably couples crankshaft 64 of engine 56 to input shaft 76 of transaxle 60. After engine 56 is adjusted to a desired location, nuts 108 are tightened upon bolts 104 to fix the location of engine 56 and second bracket 86 with respect to first bracket 84.

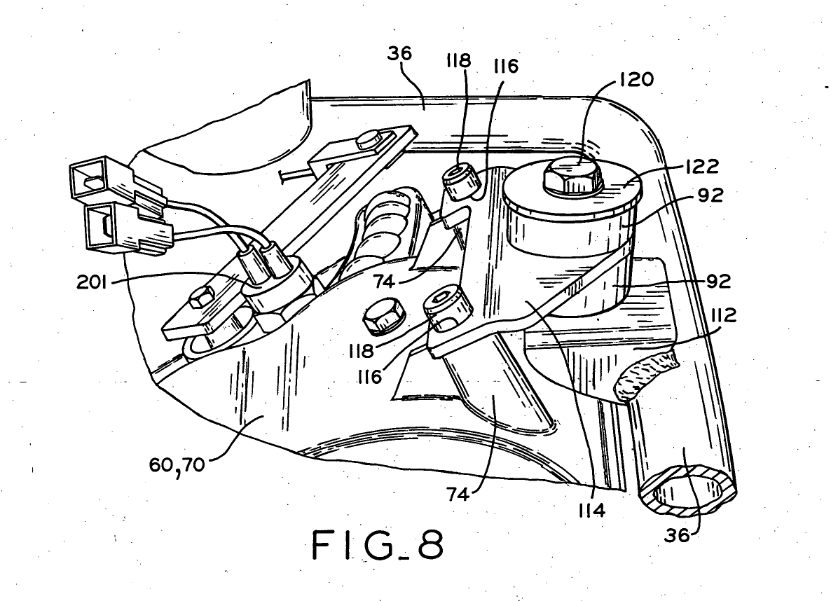

Referring to FIGS. 3 and 8, the rear portion of sub-frame 36 includes mount tab 112 to which the rear portion of transaxle 60 is attached. Rear transaxle mount bracket 114 includes a pair of spaced apertures 116 therein through which bolts 118 are received to secure mount bracket 114 to mounting bosses 74 of upper casing 70 of transaxle 60. Additionally, mount bracket 114 includes a central aperture (not visible in FIG. 8) through which another bolt 120 is received to attach mount bracket 114 to mount tab 112 of sub-frame 36. Rubber bushings 92 are disposed between mount bracket 114 and mount tab 112, and between mount bracket 114 and washer 122 beneath the head of bolt 120, to dampen or absorb vibration between sub-frame 36 and transaxle 60.

Referring to FIG. 9, a second mounting assembly 58b is shown, in which engine 56 is not adjustably mounted. In mounting assembly 58b, four bolts 124 are inserted through mounting holes 106 in crankcase 62 of engine 56 and into corresponding mounting bosses 74 transaxle 60 to fixably secure engine 56 to transaxle 60. Transaxle 60 additionally includes lower mounting bosses 128 which are attached with suitable fasteners (not shown) to a bracket (not shown) which is mounted to sub-frame 36 of go-kart 20. The mounting bosses 74 at the rear of transaxle 60 are used to mount the rear portion of transaxle 60 to sub-frame 36 in the same manner described above with reference to FIG. 8. In this embodiment, power train unit 54 additionally includes pulley 130 mounted to crankshaft 64 of engine 56, and pulley 132 mounted to input shaft 76 of transaxle 60, with belt 134 disposed around pulleys 130 and 132 to drivingly couple crankshaft 64 of engine 56 to input shaft 76 of transaxle 60. Additionally, a belt tensioning mechanism 136 may be provided, which is adjustable by an operator to vary the tension on belt 134. For example, a clutch (not shown) may be used to control belt tensioning mechanism 136, wherein depression of the clutch reduces the tension of belt 134 to allow shifting of transaxle 60 between neutral and forward or reverse drive positions, and release of the clutch tensions belt 134 to drivingly couple crankshaft 64 of engine 56 to input shaft 76 of transaxle 60.

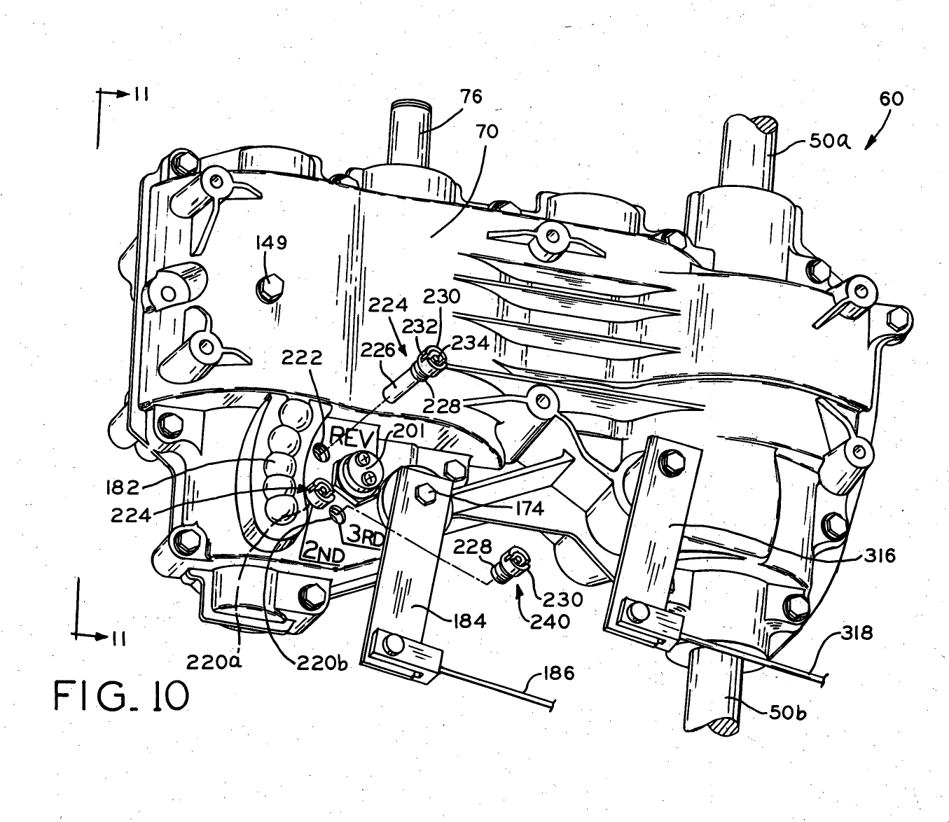

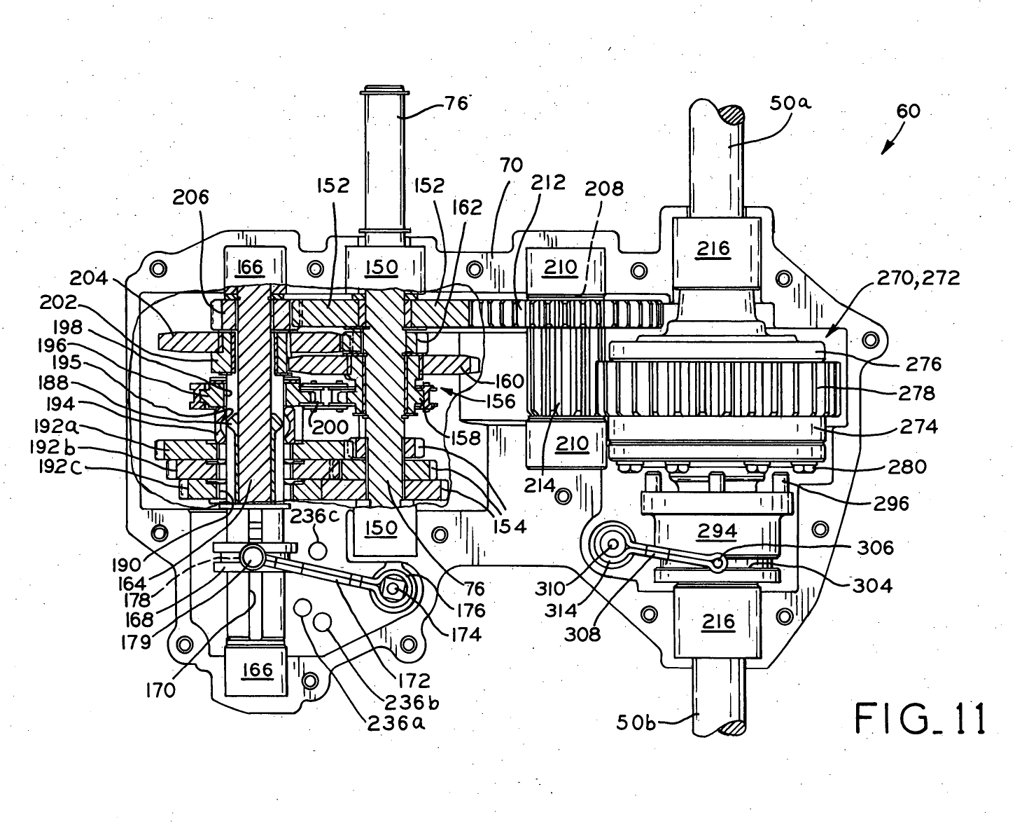

With reference to FIGS. 10 and 11, transaxle 60 will be described. Transaxle 60 is enclosed by upper and lower casings 70 and 72, and contains an oil bath therein for lubricating the various moving components within transaxle 60. Upper casing 70 includes vent 149 (FIG. 10) for venting air pressure between the interior of transaxle 60 and the atmosphere as necessary. Referring to FIG. 11, input shaft 76 is rotatably supported in a pair of needle bearings 150 carried by upper and lower casings 70 and 72 of transaxle 60, and gear 152 is freely rotatable upon input shaft 76. Three forward companion gears 154 are keyed to input shaft 76 for rotation therewith. Reverse sprocket/gear 156 is freely rotatable upon input shaft 76, and includes sprocket portion 158 and gear portion 160. Reverse gear 162 is keyed to input shaft 150.

Shift shaft 164 is rotatably supported in a pair of needle bearings 166 carried by upper and lower casings 70 and 72 of transaxle 60, and includes shift collar 168 slidable axially along shift shaft 164 upon ridge 170 of shift shaft 164. Shift fork 172 includes shaft 174 rotatably supported in bushings 176 carried in upper in and lower casings 70 and 72 of transaxle 60 (only one bushing 176 is visible in FIG. 11), and includes a pair of opposed fingers 178 (FIG. 12) engageable within external annular groove 180 of shift collar 168. An upper finger 178 of shift fork 172 additionally includes a spring-loaded detent member 179 (FIG. 12) selectively positionable within one of a plurality of detent recesses 182 (FIG. 10) which are formed within upper casing 70 of transaxle 60 to positively locate shift fork 172 in any one of the operator-selected neutral, drive, or reverse positions which are discussed below. Further details of the foregoing detent mechanism for positively locating shift fork 172 are disclosed in U.S. Pat. No. 5,094,121, assigned to the assignee of the present invention, the disclosure of which is expressly incorporated herein by reference.

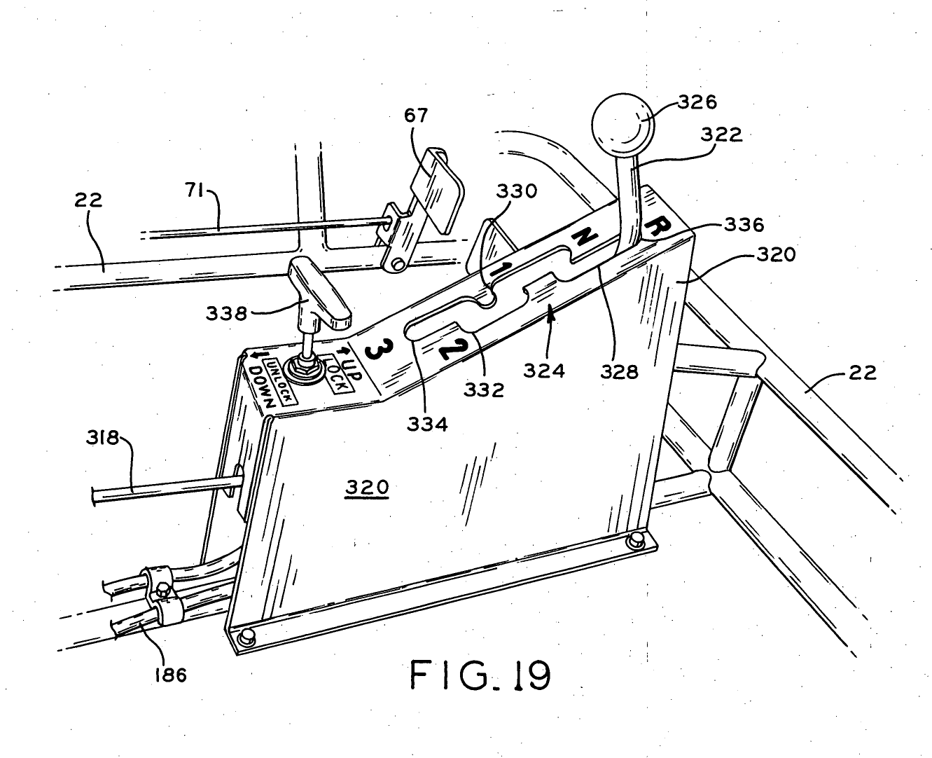

Referring to FIGS. 10 and 12, an end of shaft 174 extends externally of transaxle 60, and includes shift lever 184 thereon which is connected to cable 186. An opposite end of cable 186 is connected to operator-controlled shift lever 330 (FIG. 19), described below, for translating cable 186 to shift transaxle 60 between neutral and forward and reverse drive positions. Translation of cable 186 by shift lever 330 rotates shift lever 184, shaft 174, and shift fork 172 to translate shift collar 168 to shift transaxle 60 between neutral and selected forward and reverse drive positions, as discussed below.

Referring to FIG. 11, shift collar 168 includes a plurality of shift keys 188 extending therefrom which are slidably disposed within grooves of shift shaft 164. Shift keys 188 are engageable within forward keyways 190 provided in each of three forward gears 192a-c supported for rotation on shift shaft 164 to drivingly couple shift shaft 164 to a selected one of the three forward gears 192a-c. Forward gears 192a-c include first forward gear 192a for low speed forward drive, second forward gear 192b for medium speed forward drive, and third forward gear 192c for high speed forward drive. Additionally, shift shaft 164 includes neutral sleeve 194 with neutral keyway 195 in which shift keys 188 are received to shift transaxle 60 into a neutral position, as described below.

Reverse sprocket 196 is supported on shift shaft 162, and includes reverse keyway 198 which may be engaged by shift keys 188 to drivingly couple shift shaft 164 to reverse sprocket 196 for reverse drive. Reverse sprocket 196 is drivingly coupled to sprocket portion 158 of reverse sprocket/gear 156 of input shaft 76 by chain 200. Reverse gears 202 and 204 are supported on shift shaft 164, and gear 206, which is keyed to shift shaft 164, engages gear 152 of input shaft 76. Optionally, in place of chain 200, the reverse drive assembly could be configured with a gear drive only.

Transfer shaft 208 is rotatably supported in a pair of needle bearings 210 carried by upper and lower casings 70 and 72 of transaxle 60, and includes first transfer gear 212 and second transfer gear 214 keyed thereto, with second transfer gear 214 in engagement with ring gear 278 of differential 270. As described below, differential 270 transfers rotary motion to left and right rear axles 50a and 50b, which are rotatably supported in bearings 216 carried by upper and lower casings 70 and 72 of transaxle 60.

For forward motion, shift fork 172 is shifted to move shift collar 168 to a position in which shift keys 188 engage a forward keyway 190 of a selected forward gear 192a-c. In this manner, one of the forward companion gears 154 rotatably drives its corresponding forward gear 192a-c to rotate shift shaft 164, and gear 206 of shift shaft 164 drives gear 152 on input shaft 76, which in turn drives first transfer gear 212 and transfer shaft 208, with second transfer gear 214 driving ring gear 278 of differential 270. Differential 270 transmits rotation to rear axles 50a and 50b in the manner described below.

For reverse drive, shift fork 172 is shifted to move shift collar 168 to a position in which shift keys 188 engage reverse keyway 198 of reverse sprocket 196. In this manner, reverse sprocket 196 is coupled to shift shaft 164 such that gear 162 of input shaft 76 drives reverse gears 202 and 204 and reverse sprocket/gear 156, which drives reverse sprocket 196, and gear 206 of shift shaft 164 drives gear 152 on input shaft 76, which in turn drives first transfer gear 212 and transfer shaft 208, with second transfer gear 214 driving ring gear 278 of differential 270.

In neutral, shift fork 172 is shifted to move shift collar 168 to a position in which shift keys 188 engage neutral keyway 195 of neutral sleeve 194, as shown in FIG. 11, and shift shaft 164 is not rotatably coupled to any of forward gears 192a-c or to reverse sprocket 196. In this neutral position, forward gears 192a-c and reverse sprocket 196 rotate freely on shift shaft 164, and no rotary power is transferred from transaxle 60 to left and right rear axles 50a and 50b. Transaxle 60 may be equipped with a neutral start switch 201 (FIGS. 8, 10, 12, and 13a) connected to shift fork 172, which permits starting of engine 56 only when transaxle 60 is shifted to its neutral position.

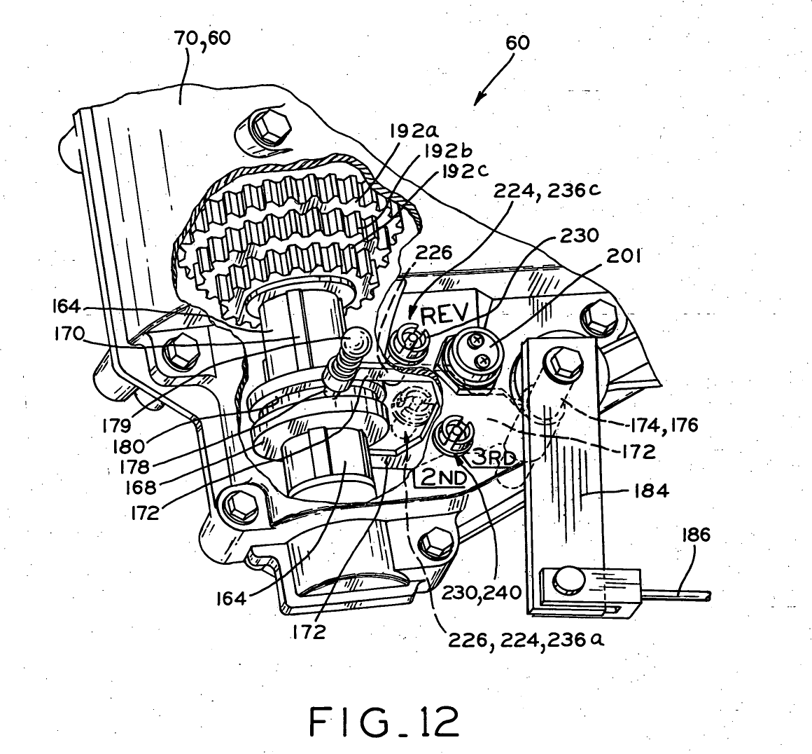

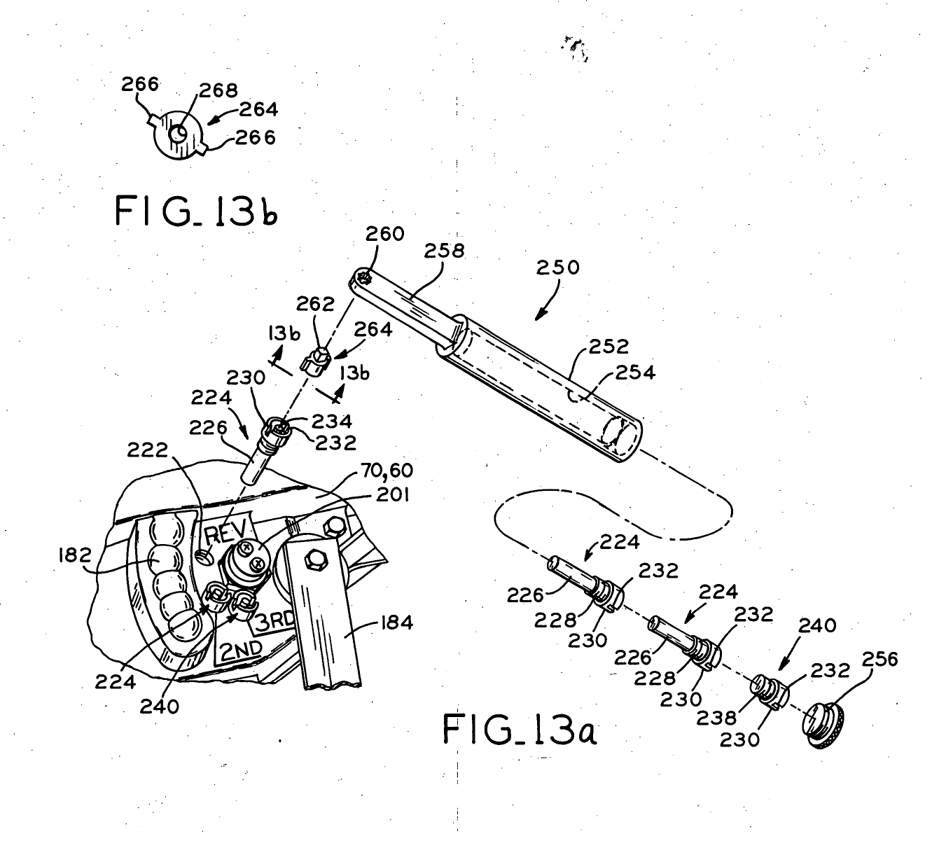

Transaxle 60 additionally includes a selective drive lockout feature to lock out selected forward gears 192b or 192c and/or reverse sprocket 196 in order to prevent same from being used. Referring to FIGS. 10-13a, upper transaxle casing 70 includes first, second, and third threaded apertures 220a, 220b, and 222 each adapted to receive lock pins 224 which extend interiorly into transaxle 60 as shown in FIG. 12. Lock pins 224 each include elongate shaft portion 226 having threads 228, and head 230. Head 230 of each lock pin 224 is configured with slot 232 and pin 234, such that lock pins 224 may only be engaged using a tool of the type shown in FIG. 13a, which is described below.

Referring to FIGS. 11-13a, when a lock pin 224 is inserted through first aperture 220a, shaft portion 226 of the lock pin 224 extends into transaxle casings 70 and 72 at a first location 236a (FIG. 11) disposed proximate shift fork 172. When a lock pin 224 is disposed in position 236a, shift fork 172 may move between the neutral position and a first forward drive position in which shift keys 188 engage keyway 190 of first forward gear 192a for forward drive of transaxle 60 and go-kart 20. However, at location 236a, the lock pin 224 blocks shift fork 172 from further rotational movement from the first drive position, such that shift fork 172 cannot move to second or third forward drive positions in which shift keys 188 engage keyways 190 of second or third forward gears 192b or 192c. In this manner, second and third forward gears 192b and 192c are locked out, and shift fork 172 may only be actuated to shift transaxle 60 between neutral and a first forward drive position in which only first forward gear 192a is used. In forward drive with first forward gear 192a, the overall speed of go-kart 20 is limited to that which is allowed by first forward gear 192a.

When a lock pin 224 is inserted through second aperture 220b, shaft portion 226 of same extends into transaxle casings 70 and 72 at a second location 236b (FIG. 11) proximate shift fork 172. At location 236b, the lock pin 224 allows movement of shift fork 172 between the neutral position and first and second forward drive positions in which shift keys 188 may engage keyways 190 of first and second forward gear 192a and 192b for forward drive of transaxle 60 and go-kart 20. However, at location 236b, the lock pin 224 blocks shift fork 172 from further rotational movement from the first and second drive positions, such that shift fork 172 cannot move to a third forward drive position in which shift keys 188 engage keyway 190 of third forward gear 192c. In this manner, third forward gear 192c is locked out, and shift fork 172 may only be actuated to shift transaxle 60 between neutral and first and second forward drive positions in which only first and second forward gears 192a and 192b are used. In the first and second forward drive positions using first and second forward gears 192a and 192b, the overall speed of go-kart 20 is limited to that which is allowed by first and second forward gears 192a and 192b.

When lock pins 224 are not inserted into either of first or second apertures 220a and 220b, shift fork 172 is not blocked, but may move between neutral and any of its first, second, or third forward drive positions in which any of first, second, or third forward gears 192a, 192b, and 192c are used, allowing go-kart to be driven at low speed, medium speed, or high speed.

When a lock pin 224 is inserted through third aperture 222, shaft portion 226 of same extends into transaxle casings 70 and 72 at a third location 236c (FIG. 11) proximate shift fork 172. At location 236c, the lock pin 224 blocks movement of shift fork 172 from the neutral position toward to the reverse drive position, such that shift fork 172 cannot move to a position in which shift keys 188 engage keyway 198 of reverse sprocket 196. In this manner, reverse sprocket 196 is locked out and cannot be used, such that transaxle 60 and go-kart 20 cannot be driven in reverse.

When a lock pin 224 is not inserted into any of first, second, or third apertures 220a, 220b, or 224 a plug 240 is inserted into the aperture 220a, 22b, or 224 in order to prevent leakage of oil from within transaxle 60 through first, second, or third apertures 220a, 220b, or 224. Plugs 240 each include threads 228 and head 230 identical to that of lock pins 224; however, plugs lack shaft portions 226. Thus, when plugs 240 are inserted into first, second, or third apertures 220a, 220b, or 224, plugs 240 do not block movement of shift fork 172. Advantageously, mechanically locking lock pins 224 to the transmission by, e.g., threading them into threaded apertures in the transmission housing allows for lockout of certain forward and reverse speeds of the vehicle, which lockout cannot be easily disengaged during operation of the vehicle. While the selective drive lockout feature of the present invention has been described with respect to a transaxle, it is equally applicable to a transmission. Further, while described with respect to a gear transmission, the selective drive lockout feature of the present invention is equally applicable to other types of transmissions such as, e.g., hydrostatic transmissions.

In FIG. 13a, tool 250 is shown for installing lock pins 224 or plugs 240 within apertures 220a, 220b, and 222 of transaxle 60. Tool 250 includes handle portion 252 having cavity 254 therein which is closed by a removable cap 256. Cap 256 may be removably attached to handle portion 252 by threaded engagement, as shown in FIG. 13a, or by snap-fit or in another suitable manner. A plurality of lock pins 224 and/or plugs 240 may be stored within cavity 254 in handle portion 252 of tool 250 when same are not installed within apertures 220a, 220b, and 222 of transaxle 60. Wrench portion 258 extends from handle portion 252, and includes fitting 260. Fitting 260 is configured as an opening within wrench portion 258 which is shaped as two squares superimposed upon one another, and is therefore shaped to engage square end portion 262 of tool head 264. Referring additionally to FIG. 13b, tool head 264 includes lugs 266 on opposite sides thereof for engaging slots 232 in head 230 of lock pins 224 or plugs 240. Additionally, tool head 264 includes hole 268 adapted to receive pins 234 of heads 230 of lock pins 224 or plugs 240. Thus, tool 250 and tool head 264 may be used to engage heads 230 of lock pins 224 or plugs 240 to threadably install or remove lock pins 224 or plugs 240 within apertures 220a, 220b, and 222 of transaxle 60.

Notably, the heads 238 of lock pins 224 and plugs 240, and tool head 264, are specially configured in the complementary manner shown herein to engage only with one another, such that heads 230 of lock pins 224 and plugs 240 may not be operatively engaged by conventional hand tools such as screwdrivers, open-end wrenches, or hexagonal sockets, for example. The configuration of heads 238 of lock pins 224 and plugs 240, and of tool 250 shown herein, is only exemplary. Other complementary configurations for lock pins 224, plugs 240, and tool 250 which permit lock pins 224 and plugs 240 to be installed within, or removed from, apertures 220a, 220b, and 222 of transaxle 60 only by the use of tool 250 may be developed by one of ordinary skill in the art. Thus, tool 250 is required to install or remove lock pins 224 or plugs 240 within apertures 220a, 220b, and 222 of transaxle 60 in order to selectively configure the selective lockout mechanism of transaxle 60.

The foregoing selective drive lockout feature allows the performance characteristics of transaxle 60 and, in turn, go-kart 20 to be specifically tailored for selected applications in which go-kart 20 is used. For example, when go-kart 20 is being operated by an experienced or trained user, three plugs 240 may be inserted within apertures 220a, 220b, and 222 of transaxle 60 to allow the use of all three forward gears 192a, 192b, and 192c, as well as reverse sprocket 196, such that go-kart 20 may be driven in both forward and reverse throughout its full speed range. Alternatively, when go-kart 20 is to be operated by an inexperienced user, for example, one or more lock pins 224 may be inserted through apertures 220a, 220b, and 222 of transaxle 60 to selectively lock out the second or third forward gears 192b or 192c or the reverse sprocket 196, such that go-kart 20 may be driven in only a forward direction within a limited speed range. In this manner, the selective drive lockout feature of transaxle advantageously allows the performance characteristics of go-kart 20 to be configured to match the experience or training of the operator.

Additionally, because lock pins 224 and plugs 240 are configured to be engaged only by the specially configured tool 250 described above, any unauthorized users of go-kart 20 are prevented from reconfiguring the selective drive lockout feature of transaxle 60 without access to tool 250. For example, an owner of go-kart 20 may selectively configure the selective drive lockout feature of transaxle 60 to limit the performance characteristics of go-kart 20 for use of go-kart 20 by others, and the owner may retain tool 250 in his or her possession such that users of go-kart 20 cannot reconfigure the selective drive lockout mechanism of transaxle in an unauthorized manner.

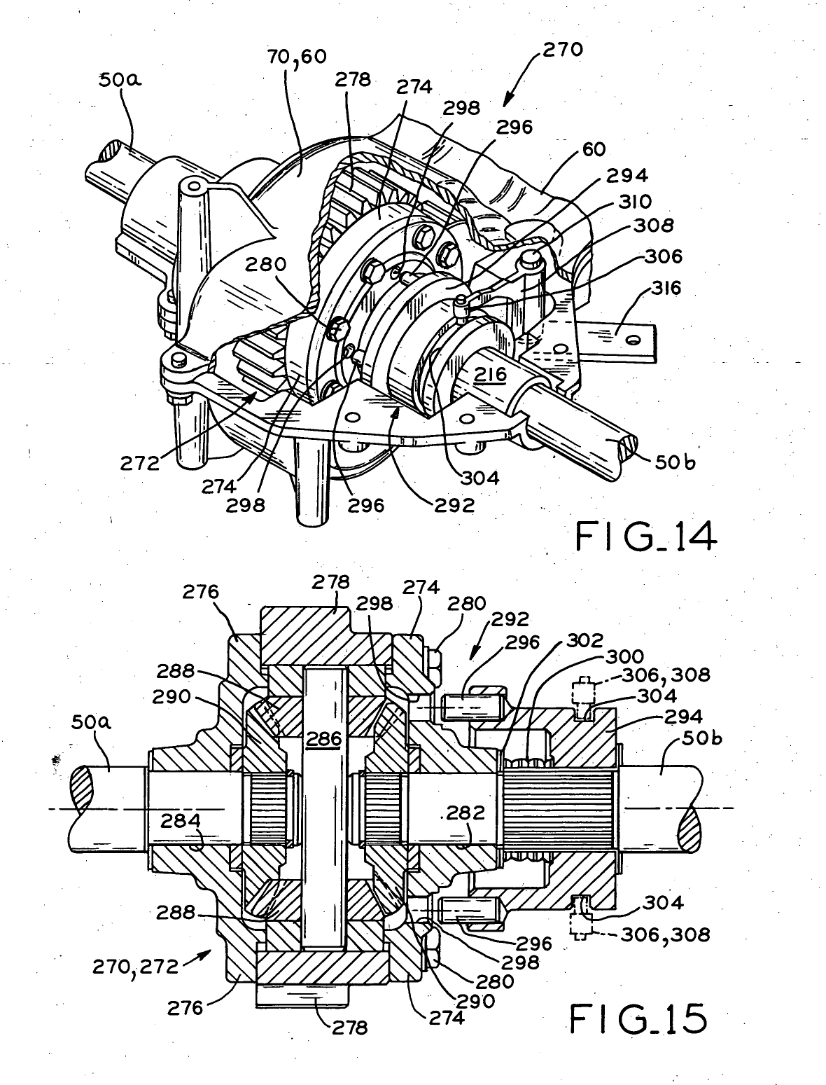

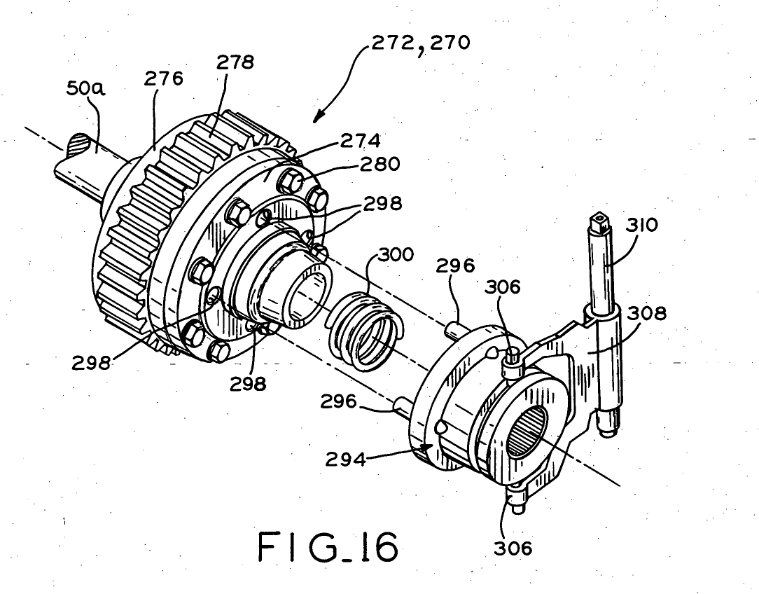

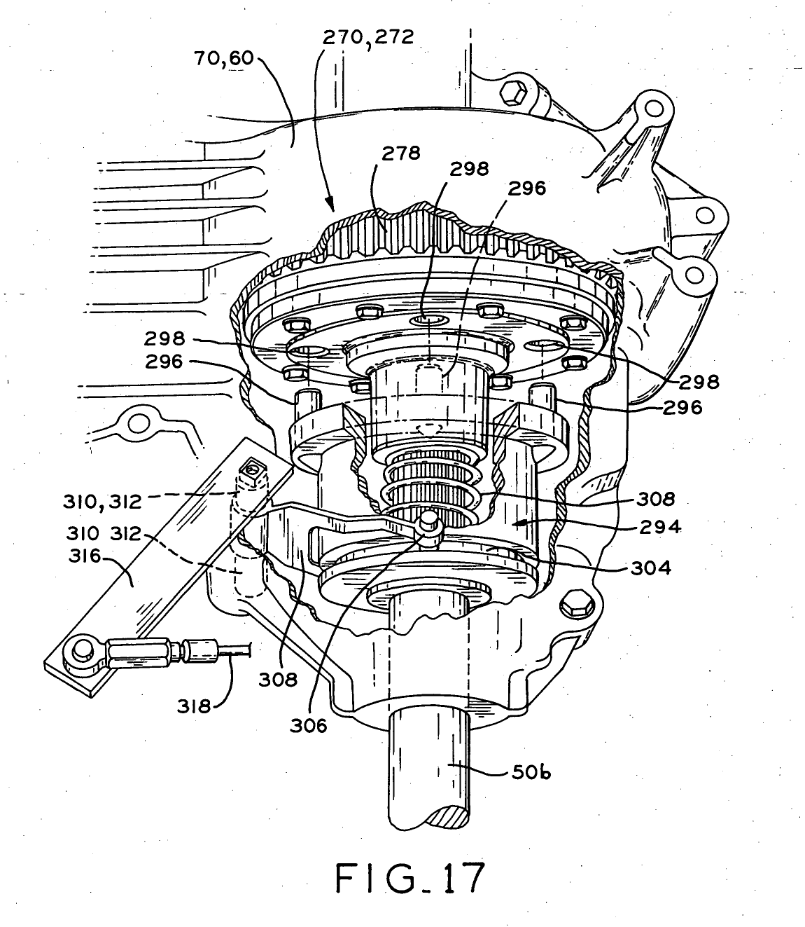

Referring to FIGS. 11 and 14-18, transaxle 60 includes a differential 270, including differential casing 272 rotatably supported within transaxle 60 upon left and right rear axles 50a and 50b. Optionally, instead of using two half axle shafts 50a and 50b, transaxle 60 could include a one-piece axle without differential 270. Referring to FIGS. 14-16 and particularly to FIG. 15, differential casing 272 includes first casing half 274, second casing half 276, and ring gear 278 disposed between first and second casing halves 274 and 276, with the foregoing components secured to one another by a plurality of bolts 280 which extend through first casing half 274 and ring gear 278 into second casing half 276. First and second casing halves 274 and 276 include bearings 282 and 284 for supporting right and left rear axles 50a and 50b, respectively. Pinion gear pin 286 is disposed within ring gear 278 and rotates therewith. A pair of pinion gears 288 are rotatably supported upon pinion gear pin 286, and are each in meshing engagement with a pair of axle gears 290 which are keyed or splined to the ends of left and right rear axles 50a and 50b.

When differential 270 is in the position shown in FIGS. 14, 15, and 17, differential 270 is “active”, and functions as follows. Specifically, when go-kart 20 is moving in a forward or reverse direction along a straight line, rotation of ring gear 278 rotates pinion gears 288 orbitally; however, pinion gears 288 do not themselves rotate upon pinion gear pin 286. In this manner, rotational torque is transferred equally through pinion gears 288 to axle gears 290 and to left and right rear axles 50a and 50 to drive left and right rear axles 50a and 50b at the same speed. When go-kart 20 is driven through a turn, however, pinion gears 288 rotate on pinion gear pin 286 in addition to rotating orbitally along with ring gear 278, and rotational torque is transferred through pinion gears 288 to left and right rear axles 50a and 50b while left and right rear axles 50a and 50b are concurrently allowed to rotate at different speeds with respect to one another.

Differential 270 additionally includes a differential lockout mechanism 292, including lock collar 294 keyed to right rear axle 50b such that lock collar 294 is constrained to rotate with right rear axle 50b, yet is permitted to move axially along right rear axle 50b. Alternatively, differential lockout mechanism 292 may be configured with lock collar 294 keyed to left rear axle 50a. Lock collar 294 includes a plurality of lock pins 296 extending therefrom in facing relationship with first casing half 274 of differential casing 272. Preferably, lock pins 296 are made from a relatively heavy, rigid metal material. First casing half 274 includes a plurality of corresponding holes 298 which are dimensioned to receive lock pins 296 therein. A compression spring 300 is disposed about right axle 50b between first casing half 274 and lock collar 294. One end of spring 300 may be attached to lock collar 294, with the opposite end abutting slide bearing 302 of first casing half 274 such that spring 300 rotates with lock collar 294. Alternatively, the foregoing arrangement may be reversed, in which spring 300 is fixed to first casing half 274 and does not rotate with lock collar 294. Spring 300 has a relatively heavy or strong spring load, and biases lock collar 294 axially along right axle 50b in a direction away from first casing half 274 to a first or “differential active” position which is shown in FIGS. 14, 15, and 17 and described below.

Lock collar 294 includes an external annular groove 304 which receives upper and lower engagement portions 306 of differential fork 308, which is rotatably mounted within transaxle 60 on shaft 310 received in suitable bushings 312 and 314 (FIGS. 11, 17, and 18) carried in upper and lower transaxle casings 70 and 72, respectively. Referring to FIGS. 10, 17, and 18, an end of shaft 310 extends externally of transaxle 60, and is attached to lever 316, which in turn is attached to cable 318. Cable 318 is operably connected at its opposite end to an operator-controlled differential lockout lever 338, which is shown in FIG. 19 and described below. Generally, differential lockout lever 338 is operable to translate cable 318 to rotate lever 316, shaft 310, and fork 308, thereby moving lock collar 294 axially along right axle shaft 50b against the bias of spring 300.

Normally, in a first or “differential active” position shown in FIGS. 14, 15, and 17, spring 300 biases lock collar 294 outwardly of first casing half 274, such that lock pins 296 of lock collar 294 are not engaged within holes 298 in first casing half 274. In this position, right and left axles 50a and 50b are not rotatably coupled to one another, wherein pinion gears 288 may rotate upon pinion gear shaft 286 in the manner described above to allow rotation of left and right rear axles 50a and 50b, and in turn the left and right rear wheels 26, at different speeds with respect to one another, such as when go-kart 20 is driven through a turn.

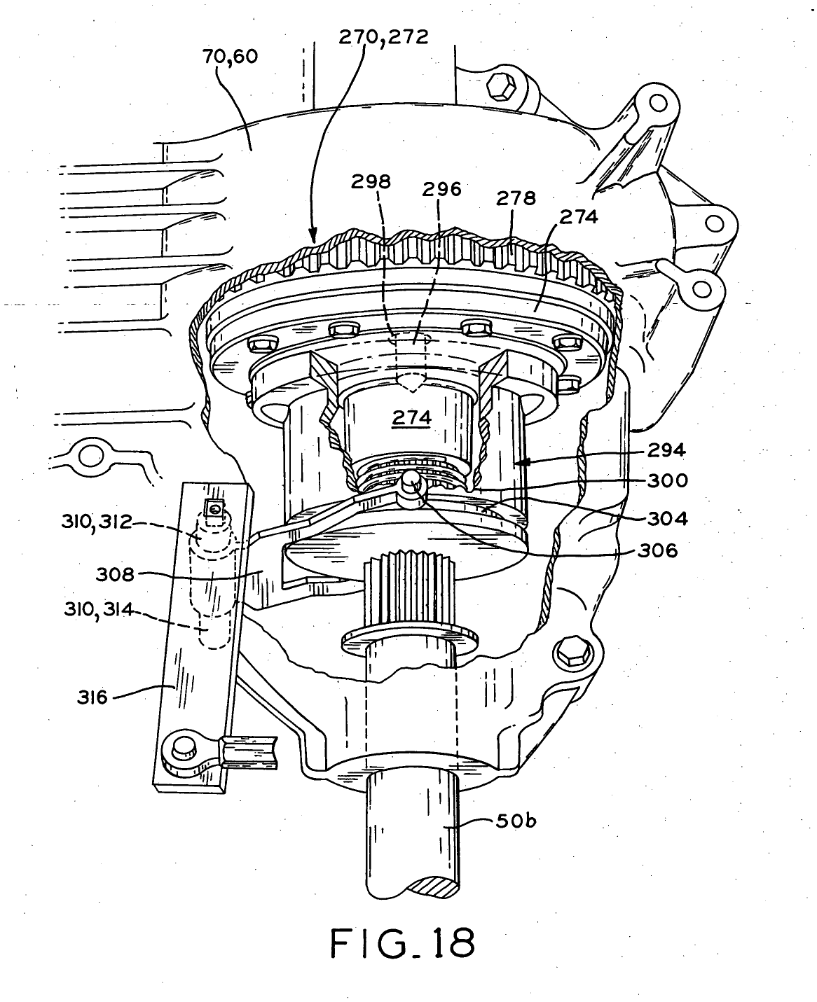

Differential 270 may be selectively locked out by an operator as follows. Actuation of differential lockout lever 338 translates cable 318 to rotate lever 316, shaft 310, and fork 308, moving lock collar 294 against the bias of spring 300 axially along right rear axle 50b toward first casing half 274 to engage lock pins 296 of lock collar 294 within holes 298 in first casing half 274, as shown in FIG. 18. The engagement of lock pins 296 of lock collar 294 within holes 298 of first casing half 274 may occur while differential casing 272 is rotating and while go-kart 20 is moving. When lock pins 296 engage holes 298 in first casing half 274, lock collar 294 and right rear axle 50b are rotatably coupled to differential casing 272, such that lock collar 294 and right rear axle 50b are constrained to rotate with differential casing 272. In this manner, axle gear 290 of right rear axle 50b is rotatably coupled to differential casing 272, rotation of pinion gears 288 upon pinion gear pin 286 is not allowed, and left and right rear axles 50a and 50b are rotatably coupled to one another. Thus, in this second position, differential 270 is locked out such that left and right rear axles 50a and 50b, and in turn, the left and right rear wheels 26, of go-kart 20 cannot rotate at different speeds.

Advantageously, differential lockout mechanism 292 is selectively operable by an operator of go-kart 20 to operate differential 270 in the above-described first or “differential active” position, in which differential 270 facilitates rotation of left and right rear axles 50a and 50b at different speeds, such that go-kart 20 may be driven more easily through turns, for example, and a second or “differential locked out” position in which left and right rear axles 50a and 50b are not permitted to rotate at different speeds, such that rear wheels 26 of go-kart 20 may obtain maximum traction when go-kart 20 is driven in dirt or mud, for example. Additionally, the engagement between lock pins 296 of lock collar 294 and holes 298 of differential casing 272 provides a very robust coupling therebetween, allowing lock pins 296, lock collar 294, and right rear axle 50b to withstand high torque loads imposed thereon by the rotation of differential casing 272.

Referring to FIG. 19, control housing 320 is shown, which may be disposed in front of seat 30 of go-kart 20, as shown in FIG. 1. Control housing 320 includes transaxle shift lever 322 operatively coupled to cable 186, with the opposite end of cable 186 coupled to shift lever 184 of transaxle 60, as shown in FIGS. 10-12 and described above. Shift lever 322 is guided for movement within shift quadrant 324 of control housing 320, and includes a knob 326 for grasping by an operator of go-kart 20 to move shift lever 322 to shift transaxle 60 between its neutral and its first, second or third forward drive positions or its reverse drive position, as described above. Shift quadrant 324 includes shift lever stop positions 328, 330, 332, 334, and 336 for guiding movement of shift lever 322 between neutral and its first, second or third forward drive positions and its reverse drive position.

Control housing 320 additionally includes differential lockout lever 338 operably connected to cable 318, with differential lockout lever 338 movable to translate cable 318 for moving differential lockout mechanism 292 between its first or “differential active” position and its second or “differential locked out” position. As described above, spring 300 of differential lockout mechanism 292 normally biases lock collar 294 to a position in which differential 270 is not locked out or is “active”. Thus, differential lockout lever 338 is normally biased to the “differential active” position. When an operator of go-kart 20 desires to lock out differential 270, the operator presses differential lockout lever 338 upwardly as shown in FIG. 19 against the bias of spring 300 to actuate differential lockout mechanism 292 and lock out differential 270. Upon release of differential lockout lever 338 by the operator, spring 300 biases differential lockout mechanism 292 and differential lockout lever 338 to the “differential active” position. Alternatively, differential lockout lever 338 may be configured to hold differential lockout mechanism 292 in the “differential locked out” position when differential lockout lever 338 is released by the operator.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A recreational vehicle, comprising:
an engine;
a transmission driven by said engine, said transmission comprising a shift mechanism moveable between a first position in which said transmission operates at a first drive speed and direction, and a second position in which said transmission operates at a second drive speed and direction; and
a first lock member selectively mechanically locked to said transmission in a first blocking position to block said selector mechanism from being positioned in said second position, while allowing said selector mechanism to be positioned in said first position.

2. The recreational vehicle of claim 1, wherein said first drive speed and direction comprises a first forward drive speed, and said second drive speed and direction comprises a second forward drive speed.

3. The recreational vehicle of claim 1, wherein said first drive speed and direction comprises a first forward drive speed, and said second drive speed and direction comprises a first reverse drive speed.

4. The recreational vehicle of claim 1, wherein said shift mechanism is further moveable between said first position, said second position, and a third position in which said transmission operates at a third drive speed and direction, said first lock member selectively mechanically locked to said transmission in a second blocking position to block said selector mechanism from being positioned in said third position, while allowing said selector mechanism to be positioned in said first and said second positions.

5. The recreational vehicle of claim 4, wherein said first drive speed and direction comprises a first forward drive speed, said second drive speed and direction comprises a second forward drive speed, and said third drive speed and direction comprises a third forward drive speed.

6. The recreational vehicle of claim 4, wherein said first drive speed and direction comprises a first forward drive speed, said second drive speed and direction comprises a second forward drive speed, and said third drive speed and direction comprises a first reverse drive speed.

7. The recreational vehicle of claim 6, further comprising a second lock member selectively mechanically locked to said transmission in said first blocking position to block said selector mechanism from being positioned in said second position.

8. The recreational vehicle of claim 1, wherein said transmission further comprises a transmission housing having an aperture, said first lock member sized for insertion through said aperture, said aperture positioned whereby when said first lock member is positioned through said aperture it maintains said first blocking position.

9. The recreational vehicle of claim 8, wherein said aperture is threaded, said first lock member is threaded, and said first lock member is threadably locked to said transmission housing when said first lock member is positioned in said first blocking position.

10. The recreational vehicle of claim 7, wherein said transmission further comprises a transmission housing having a first aperture and a second aperture, said first lock member and said second lock member sized for insertion through said first aperture and said second aperture, said first aperture positioned whereby when one of said first lock member and said second lock member is positioned through said first aperture it maintains said first blocking position, said second lock member sized for insertion through said second aperture, said second aperture positioned whereby when said second lock member is positioned through said second aperture it maintains said second blocking position.

11. The recreational vehicle of claim 10, wherein said first and said second apertures are threaded, said first and said second lock members are threaded, and said first and said second lock members are threadably locked to said transmission housing when said first and said second lock members are positioned in one of said first blocking position and said second blocking position.

12. The recreational vehicle of claim 1, wherein said transmission comprises a gear transmission.

13. The recreational vehicle of claim 9, wherein said lock member comprises a head having a transverse slot, and a boss positioned in said slot, said recreational vehicle further comprising a tool comprising a head having an aperture sized to accommodate said boss and at least one depending arm sized for insertion in said slot, said tool further comprising a handle.

14. A recreational vehicle, comprising:
a vehicle frame;
a power train unit attached to said frame, said power train unit comprising:
a mounting assembly attached to said frame,
an internal combustion engine attached to said mounting assembly, said engine including an output shaft;
a transmission attached to said mounting assembly, said transmission including an input shaft; and
a drive member drivably coupling said output shaft of said engine to said input shaft of said transaxle.

15. The recreational vehicle of claim 14, wherein said engine is adjustably attached to said mounting assembly for movement with respect to said transmission.

16. The recreational vehicle of claim 14, wherein said mounting assembly comprises:
a first bracket attached to said frame, said first bracket having at least one slot therein, said transmission attached to said first bracket; and
a second bracket disposed on a side of said first bracket opposite said engine, said second bracket and said engine attached to one another by at least one fastener which extends through said at least one slot, said second bracket and said engine together slidably adjustable with respect to said first bracket.

17. A recreational vehicle, comprising:
an engine;
a transmission driven by said engine, said transmission comprising a shift mechanism moveable between a first position in which said transmission operates at a first drive speed and direction, and a second position in which said transmission operates at a second drive speed and direction; and
locking means selectively mechanically locked to said transmission for blocking said selector mechanism from being positioned in said second position, while allowing said selector mechanism to be positioned in said first position.

18. The recreational vehicle of claim 17, wherein said first drive speed and direction comprises a first forward drive speed, and said second drive speed and direction comprises a second forward drive speed.

19. The recreational vehicle of claim 17, wherein said first drive speed and direction comprises a first forward drive speed, and said second drive speed and direction comprises a first reverse drive speed.

20. The recreational vehicle of claim 17, wherein said shift mechanism is further moveable between said first position, said second position, and a third position in which said transmission operates at a third drive speed and direction, said locking means selectively mechanically locked to said transmission to block said selector mechanism from being positioned in said third position, while allowing said selector mechanism to be positioned in said first and said second positions.

21. The recreational vehicle of claim 20, wherein said first drive speed and direction comprises a first forward drive speed, said second drive speed and direction comprises a second forward drive speed, and said third drive speed and direction comprises a third forward drive speed.

22. The recreational vehicle of claim 20, wherein said first drive speed and direction comprises a first forward drive speed, said second drive speed and direction comprises a second forward drive speed, and said third drive speed and direction comprises a first reverse drive speed.

23. The recreational vehicle of claim 22, further comprising:
second locking means selectively mechanically locked to said transmission for blocking said selector mechanism from being positioned in said second position.

24. The recreational vehicle of claim 17, wherein said transmission comprises a gear transmission.

25. A method of restricting an operator's ability to shift a transmission of a recreational vehicle, the recreational vehicle having an engine; and a transmission driven by the engine, the transmission having a shift mechanism moveable between a first position in which the transmission operates at a first drive speed and direction, and a second position in which the transmission operates at a second drive speed and direction, said method comprising the steps of:
providing a first lock member; and
mechanically locking said first lock member to said transmission in a first blocking position to block the selecter mechanism from being positioned in said second position, while allowing the selector mechanism to be positioned in the first position.

26. The method of claim 25, wherein the first drive speed and direction comprises a first forward drive speed, and the second drive speed and direction comprises a second forward drive speed.

27. The method of claim 25, wherein the drive speed and direction comprises a first forward drive speed, and the second drive speed and direction comprises a first reverse drive speed.

28. The method of claim 25, wherein the shift mechanism is further moveable between the first position, the second position, and a third position in which the transmission operates at a third drive speed and direction, wherein said first drive speed and direction comprises a first forward drive speed, said second drive speed and direction comprises a second forward drive speed, and said third drive speed and direction comprises a first reverse drive speed and wherein said method further comprises the steps of:
providing a second lock member; and
mechanically locking said second lock member to said transmission in a second blocking position to block the selector mechanism from being positioned in the third position.

29. The method of claim 25, wherein the transmission comprises a transmission housing having an aperture, the first lock member sized for insertion through said aperture, and wherein said step of mechanically locking the first lock member to the transmission in a first blocking position comprises the step of inserting the first lock member through the aperture and locking the first lock member to the transmission housing.

30. The method of claim 29, wherein the aperture is threaded, said first lock member is threaded, and the step of locking the lock member to the transmission housing comprises threadably locking the lock member to the transmission housing.

31. The method of claim 28, wherein the transmission further comprises a transmission housing having a first aperture and a second aperture, the first lock member sized for insertion through the first aperture, said second lock member sized for insertion through said second aperture, and wherein said step of mechanically locking said lock member to said transmission in a first blocking position comprises the step of inserting the first lock member through the first aperture and locking the first lock member to the transmission housing, and wherein the step of mechanically locking said second lock member to said transmission in a second blocking position comprises the step of inserting the second lock member through the second aperture and locking the second lock member to the transmission housing.

32. The method of claim 31, wherein said first aperture is threaded, said second aperture is threaded, said first lock member is threaded, said second lock member is threaded, and wherein said step of locking said first lock member to the transmission housing comprises threadably locking said first lock member to the transmission housing and wherein said step of locking said second lock member to the transmission housing comprises threadably locking said second lock member to the transmission housing.
